(19) United States
(12) Patent Application Publication
(10) Pub. No.: US 2014/0012821 A1
(43) Pub. Date: Jan. 9, 2014

(54) RELIABLE PROFILING FOR MONITORING SYSTEMS

(71) Applicants: Peter Fuhrmann, Aachen (DE); Hao Hu, Beijing (CN); Ingrid Christina Maria Flinsenberg, Eindhoven (NL)

(72) Inventors: Peter Fuhrmann, Aachen (DE); Hao Hu, Beijing (CN); Ingrid Christina Maria Flinsenberg, Eindhoven (NL)

(73) Assignee: KONINKLIJKE PHILIPS N.V., EINDHOVEN (NL)

(21) Appl. No.: 14/005,328

(22) PCT Filed: Mar. 1, 2012
(86) PCT No.: PCT/IB2012/050967

§ 371 Date: Sep. 16, 2013

(30) Foreign Application Priority Data
Mar. 17, 2011 (EP) 11158582.4

(51) Int. Cl. G06F 17/30

(52) U.S. Cl. CPC G06F 17/30371
USPC 707/691; 707/690

(57) ABSTRACT

The present invention relates to an apparatus and method for analyzing building auditing information to identify irregular usage patterns and incorrect audit information. The auditing information, such as energy consumption, is analyzed using presence information at room or zone level. Based on pre-selected expectations, clustering is applied to data sets. By using different criteria, the clustering results are examined within every cluster and among clusters to find irregular information. Furthermore, through cross-checking with other background information, irregular usage pattern can be found and incorrect audit information can be identified, so that succeeding energy prediction and decision-support algorithms can work on a reliable set of profiles.

### FIELD OF THE INVENTION

The present invention relates to an apparatus, method and computer program product for analyzing auditing information to be used in monitoring systems.

### BACKGROUND OF THE INVENTION

In a perfect world, every consumer would use a constant amount of power at all times of the day, every day of the year. Unfortunately for everybody, the world doesn't work that way. People use more power at peak hours during the day when they are operating power-hungry machines under bright fluorescent lights in air-conditioned offices, than they use at night when they are home in bed. Electric load monitoring generates important data that can help to unravel the mystery behind commercial facilities' energy usage characteristics.

The general definition of an audit is an evaluation of a system, process, enterprise, project or product. Audits are performed to ascertain validity and reliability of information and also to provide an assessment of a system's internal control. Auditing is the examination of relevant information for the intended audit and may be an initial step in energy management programs, which not only provides the building energy performance profile and energy usage measurements but also helps to identify opportunities for potential energy conservation. The objectives of building auditing and assessment generally include quantification of the energy consumption, identification of how and when it is being consumed and the definition of actual usage patterns of the building.

Building utilization assessment and usage classification can be done by referring to average numbers and rough assumptions for typical zones in a building (e.g. private offices, open space offices, corridors, etc.). As this input determines the performance of user- and usage-adaptive control strategies (like occupancy-controlled lighting/HVAC), the correct quantification of potential savings depends on the accuracy of the usage information. In order to acquire more accurate data on the actual usage pattern, building monitoring based on temporarily installed sensors is pursued as a promising concept. Such usage or load monitoring systems gather all kind of environmental and usage-specific data (room occupancy, equipment usage, actuation of blinds, interaction with doors/windows etc.). Based on that data, usage profiles and characteristics can be derived for audits, which could guide the selection of appropriate system upgrades and advanced control technology. The usage monitoring system autonomously collects huge amounts of data for a period of several weeks. In a succeeding step, the resulting database is inspected and analyzed. The goal is to convert the gathered sensor data into reliable building utilization information and usage profiles.

In order to facilitate a targeted selection of the most appropriate control system and its configuration, the data analysis process should identify and distinguish the following cases:
Incorrect measurement—Anomalies in the data sets that are caused by equipment or measurement failures.
Irregularity—Deviations from normal conditions that are caused by irregular events or periods during the monitoring interval (e.g. vacation period).
Regularity & Speciality—Commonality in the observed usage pattern in order to create representative profiles. Specialities in the regular profiles are of particular interest, as these could be addressed with adapted control strategies.

For the building assessment process, the identification of regular profiles with certain dynamics and specialities is most interestingly, as it suggests the possible system inefficiencies and energy wasting situations, and indicates further energy saving opportunities.

On the other hand, the building auditing usually involves many different types of measurements and equipments, and large amounts of auditing data. Therefore, incorrect measurements could emerge, but also irregular events could occur during the observation period. For instance, business trips or vacation periods could massively alter and bias the occupancy pattern and the derived profile for a certain room and user.

In order to obtain accurate analysis results from the auditing data, such incorrect data should be identified and removed before the auditing data is further processed and translated into representative profiles. As the amount of data is increasing and scales with the size of the building, automatic procedures and algorithms should be deployed as manual inspection becomes infeasible.

Also the identification of the regularities/commonalities from the auditing information is usually done by manual inspection over individual room/zone usage measurements. With limited information, the identification of this information is not very reliable and accurate. As the energy systems nowadays get more and more sophisticated, the amount of the auditing information dramatically increases and it is not trivial to find specialities in regular profiles using conventional approaches.

### SUMMARY OF THE INVENTION

It is an object of the present invention to identify regular data patterns in collected auditing data sets and to distinguish these regular patterns from incorrect and/or irregular data.

This object is achieved by an apparatus as claimed in claim 1, a method as claimed in claim 9, and a computer program product as claimed in claim 16.

Accordingly, similar profiles can be automatically clustered and analyzed to identify regular data. Furthermore, clues about potentially incorrect or irregular data sets can be provided. Moreover, incorrect data can be identified and validated by cross-checking with other background information.

According to a first aspect, auditing information from which incorrect data sets have been removed may be processed and translated into representative profiles. Thus, reliability of the obtained profiles and the resulting audit can be enhanced.

According to a second aspect which can be combined with the above first aspect, at least one root cause of irregularity may be determined, and a determined irregular data set may be corrected into a regular data set based on the at least one root cause. Thereby, the number of regular data sets can be increased to improve reliability of the processed auditing information. As an example, the irregular data set may be corrected based on an interpolation of valid measurement samples. It is noted that interpolation is one option for correcting the irregular data set. It is however not the only way. For example, a model could be built for the regular data set, which model is then used to correct the irregular data set. Such models could be a regression model, a rule model, a decision tree model, etc.

According to a third aspect which can be combined with the above first or second aspect, the auditing information may comprise presence information and measurement values of energy consumption at a predetermined acquisition rate. In this exemplary case, a distance between presence profiles could be used as the predetermined clustering criteria. Then, for example, a K-means algorithm could be applied to cluster the profile using said distance.

According to a fourth aspect which can be combined with any of the above first to third aspects, an iterative approach may be applied, where data sets of a single area (e.g. room, floor, partial building etc.) of a building or floor are first clustered to determine irregular or incorrect patterns for the single areas and then the data sets of the areas are clustered in their entirety or in groups. Thereby, irregular or incorrect patterns of smaller areas, which would otherwise be blurred in the patterns of larger areas, can be detected and removed.

The above apparatus may be implemented as a hardware circuit integrated on a single chip or chip set, or wired on a circuit board. As an alternative, at least parts of the apparatus may be implemented as a software program or routine controlling a processor or computer device.

It shall be understood that the apparatus of claim 1, the method of claim 9, and the computer program of claim 16 have similar and/or identical preferred embodiments, in particular, as defined in the dependent claims.

It shall be understood that a preferred embodiment of the invention can also be any combination of the dependent claims with the respective independent claim.

These and other aspects of the invention will be apparent from and elucidated with reference to the embodiment described hereinafter.

### BRIEF DESCRIPTION OF THE DRAWINGS

In the following drawings:

FIG. 1 shows schematic functional block diagram of a processing apparatus according to an embodiment;

FIG. 2 shows an example of one-day auditing information;

FIG. 3 shows an example of average monthly occupancy profiles obtained from five clusters; and

FIG. 4 shows a table indicating clustering results and background information.

### DETAILED DESCRIPTION OF EMBODIMENTS

The following embodiment is based on an analysis of energy auditing information to provide reliable profiling.

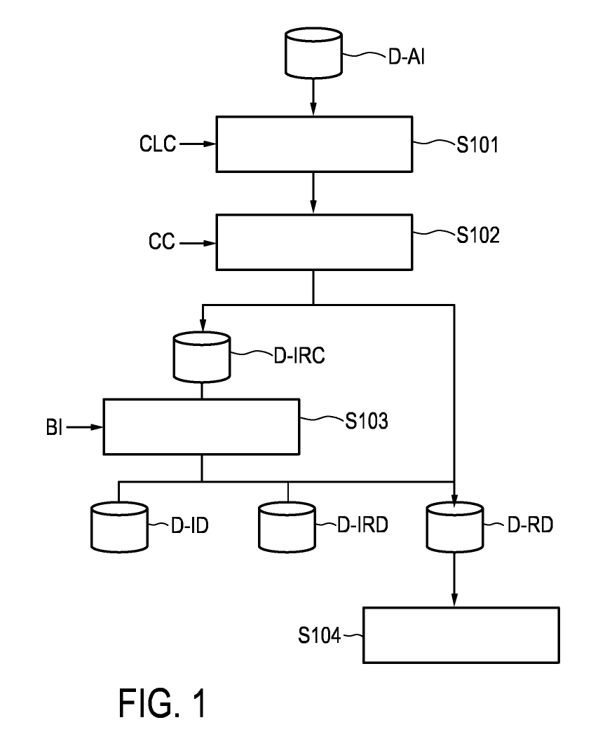

FIG. 1 shows a schematic functional block diagram of a processing apparatus or analyzing procedure according to the embodiment. Auditing information or history data about the building energy usage is stored in an auditing information memory or database D-AI and is used as input to a clustering unit, stage or step S101 of the processing apparatus or analyzing procedure. The auditing information is clustered in the clustering stage or step S101 automatically by the use of clustering criteria (CLC) and clustering techniques such as the K-means algorithm as specified for example in J. B. MacQueen (1967): “Some Methods for classification and Analysis of Multivariate Observations, Proceedings of 5-th Berkeley Symposium on Mathematical Statistics and Probability”, Berkeley, University of California Press, 1:281-297. K-means clustering is a method of cluster analysis which aims to partition n observations into k clusters in which each observation belongs to the cluster with the nearest mean. It attempts to find the centers of natural clusters in the data as well as in the iterative refinement approach employed by the algorithm. As an alternative, the similar expectation-maximization algorithm for mixtures of Gaussians could be applied or other suitable clustering techniques As an example, the distance between data profiles can be used as at least one of the clustering criteria.

The above clustering process is used to identify distinguishable data sets with sufficient commonality, for which the analysis of their specialities concerning the suitability of energy saving measures could be started in a subsequent comparison unit, stage or step S102. Within every cluster and among such clusters, comparison criteria (CC) such as for instance ‘below average thresholds’ can be used to find potentially irregular or incorrect data profiles and clusters. This can be seen as a generation of clues for the analysis. Regular data sets are stored in a memory or database D-RD and irregular candidates are stored in a memory or database D-IRC. Finally, by cross-checking with other background information (BI) in a checking unit, stage or step S103, irregular usage and incorrect measurements can be identified and validated. Such background information may relate to specific conditions that might be the cause of the identified irregularities or errors. Based on the checking result, irregular candidates are stored in a memory or database D-ID for incorrect data sets, if the candidate has been determined to be an incorrect data set, in a memory or database D-IRD for irregular datasets, if the candidate has been determined as an irregular data set, or in the memory or database D-RD for regular data sets, if the candidate has been determined as a regular data set.

The clustering in the clustering stage or step S101 is used to identify sets/clusters that are sufficiently ‘different’—so, in that stage or step, profiles for which we might find sophisticated energy saving solutions could be found are already determined. The comparison in the comparison stage or step S102 is done to separate irregular or incorrect data sets of profiles from the regular ones. Cross-checking in the checking stage or step S103 is done to differentiate irregular from incorrect and to validate whether a ‘candidate’ is really irregular or whether it has to be treated as a valid speciality (i.e. a regular dataset).

As the rigorous selection would tag and filter out many datasets as ‘irregular’, the suggested processing in the checking stage or step S103 can be enhanced by a succeeding correction step. This correction is applied to the determined irregular datasets, with the intention to turn them into valid, regular datasets for further processing.

In order to successfully correct a dataset, at least one root cause of the irregularity has to be known. E.g., for an irregular occupancy pattern data set, the period of irregular absence (e.g. vacation) could be determined, clarified and validated. If there is a sufficient number of valid measurement samples that allow to identify the regular pattern, the irregular period could be corrected, e.g. by interpolation. With this ‘correction’, some of the irregular data sets could be turned into regular datasets, and thus, the database D-RD of regular data sets for further processing and audit analysis in stage or step S104 becomes more stable and comprehensive.

In the following, a more detailed description of an exemplary implementation is provided. The implementation is based on an analysis of energy measurement over a period of 1 month, covering an office area, which consists of about 19 office rooms and 1 laboratory (lab). The building energy auditing information includes energy consumption measured for the lighting installation and presence information at a predetermined acquisition rate (e.g. 10 samples/hour). The presence sensor has a time-out of 30 minutes.

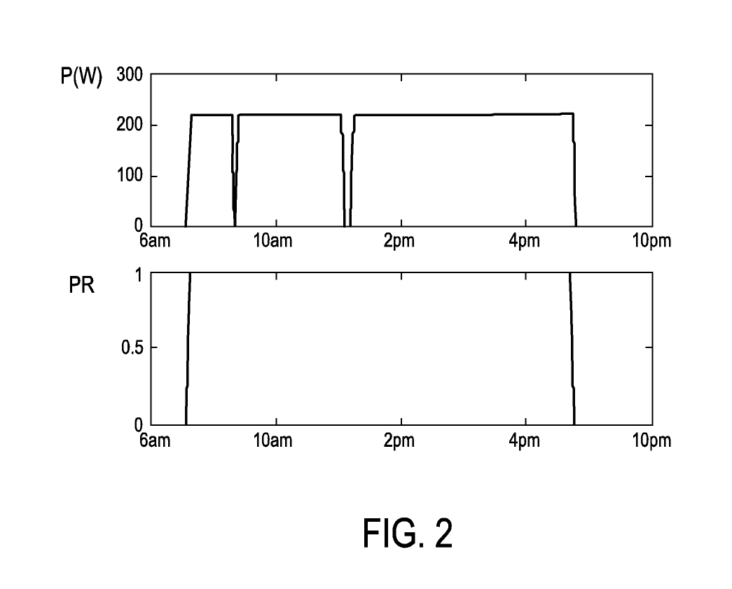

FIG. 2 shows an exemplary data set for a single day and one particular room. The upper diagram shows energy usage over time and the lower diagram shows presence information over time. The presence information is of binary data type, i.e. ‘1’ stands for presence and ‘0’ stands for absence.

For every room, the daily presence profile is accumulated to obtain the monthly presence profile. Then, a clustering operation is applied to the 20 monthly presence profiles. As an example, the Euclidean distance between profiles is used as the clustering criteria. Additionally, the K-means algorithm is used to automatically cluster the profile using the distance criteria.

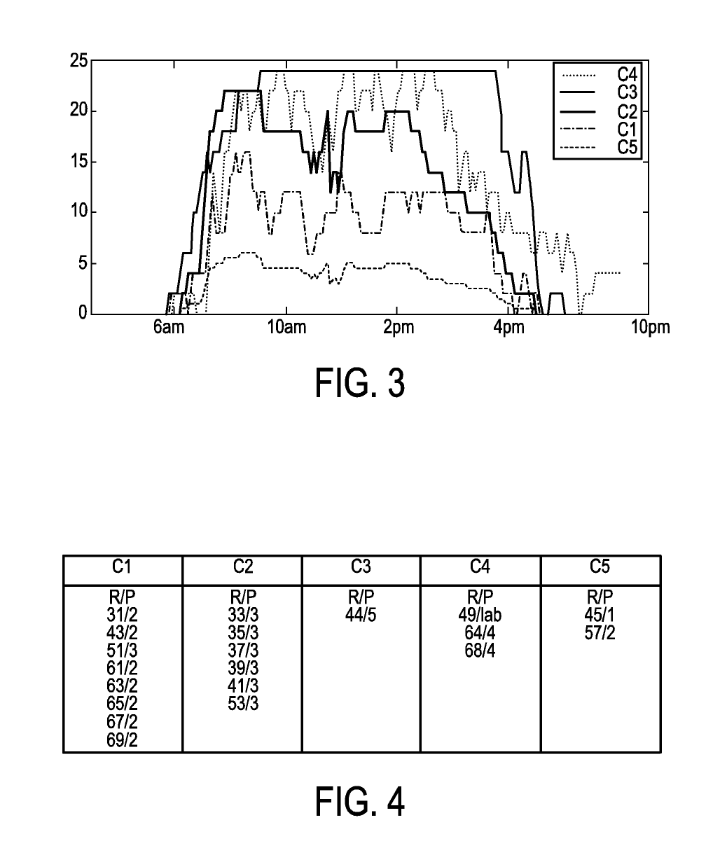

FIG. 3 illustrates the average profiles of five clusters C1 to C5 obtained from the clustering process. By examining the results of FIG. 3, it can be gathered that cluster C5 shows a peculiar presence pattern, since it indicates significantly lower presence (days per month) compared to the others.

Now, further background information is introduced, which is shown in the table of FIG. 4. In this case, the room type (number of office workers per room) is annotated to the individual data sets. Of course, other options for background information can be used, as explained later. From this enriched information, one can see that there is a 2-person room also included in the cluster C5. This inhomogeneity provides the clue for further validation needs. Thus, rooms No. 45 and 57 can be identified as ‘irregular data’ candidates. Through checking the absence list of the office workers, it becomes clear that one person from room No. 57 was taking holiday during the auditing period. As a consequence, the profile of room No. 57 profile can be regarded as an irregular data set and, thus, it will not be used for further auditing analysis in stage or step S104 of FIG. 1.

Also for room No. 45, i.e. a single person office, it has to be checked whether the presence during the monitoring period is exceptional or to be seen as regular behaviour. In the latter case, this speciality could be prone to improvements provided by advanced control.

Alternatively, the irregular profile of room 57 can be used to strengthen the data set for single person rooms. This may lead to more advanced control strategies for rooms that are only partly occupied.

Besides the number of workers in an office, the type of office also provides additional information on the typical presence pattern. For example, a service area such as e.g. a reception area can be expected to be occupied most of the time as it needs to serve customers. An area with software engineers or students for office work also are typically occupied most of the time, as both groups tend to do mainly desk work. Lab areas that are only used during tests are expected to be empty more often. Areas occupied by managers or customer relations personnel typically either receive many visitors or go to visit others, so these may be less frequently occupied as well. This information may additionally be used as the above background information for steering the clustering and the succeeding validation process. Additionally, a calendar with public and company specific mandatory holidays can act as background information as well.

In addition to investigating irregular room profiles, a similar strategy can be used to find irregular patterns for a particular room. To investigate if within each month there are some irregular days for a particular room, or even multiple regular patterns for a single room, the daily presence profiles can be clustered as well. The clustering result may indicate different patterns over the course of a week, or one or more irregular patterns during the month. The irregular daily patterns should be removed from the set before the monthly pattern is determined, because irregular daily patterns can potentially and significantly influence the monthly pattern. If the clustering of daily patterns reveals multiple regular patterns over the course of a week, for instance the presence pattern of a regular Monday is significantly different from that of a regular Friday, it is advisable to use these patterns for the room clustering analysis.

Finally, significant differences can also occur over time. Typically, the presence pattern during normal office hours is significantly different from that during the night. In case of work shifts, there may be 2 or 3 distinct periods in the day that need to be analysed separately. The presence patterns during these periods typically have no relation to each other, so they should be treated separately when clustering presence patterns. For the typical night hours in a regular office, the presence pattern in an office building is mostly very low, and presence peaks due to night guards or security personnel tend to be short. Any regularity in these night hours therefore tends to disappear in a clustering algorithm based on presence patterns of the entire day. Whether this is problematic depends on the application and the target building.

The background information used in stage or step S103 for steering the clustering and the succeeding validation process could also come from a-priori knowledge (and expertise), or from the project- and building-specific briefing, e.g. the information that only part-time workers are employed. Other options for background information could be room type, calendar information, and time.

In a modified embodiment, the apparatus of FIG. 1 could also be modified by applying an iterative approach, where the clustering stage or step S101 first clusters data sets of a single area of a building or floor to determine irregular or incorrect patterns for said single areas and then clusters the areas in their entirety or in groups. Thus, irregular or incorrect data are first determined for a single room or area, and after removing that data, the overall pattern for the room or area is determined, followed by the comparison between rooms or areas. Hence, in this iterative approach, data sets of a room, floor, partial building etc. are first clustered to determine irregular or incorrect patterns for sub-areas and then the data sets of the total area are clustered in their entirety or in groups.

If the typical occupancy pattern for an area is determined by using the average pattern over a time-period (e.g. a month), the average pattern can be significantly impacted by irregular or incorrect day-patterns, because taking the average is sensitive to outliers. As a result, the typical occupancy pattern for that area does not reflect reality, and the auditing process may lead to wrong conclusions. To remedy this problem, the irregular and incorrect day-patterns can be removed before determining the typical occupancy pattern. An alternative solution is to use measures that are less sensitive to outliers, such as the median, to determine the typical occupancy pattern. A combination of both, i.e. first remove the irregular and incorrect patterns, and secondly use e.g. the median to determine the typical occupancy pattern is most advantageous.

Although the present invention has been described in connection with building energy auditing systems to automatically identify irregular and incorrect auditing data in the most reliable way, the invention could as well be used in environments where other similar auditing or assessment systems and methods are needed. It is specifically relevant for environments, where a collection of multi-variate (multiple kinds of) information needs to be processed to derive a conclusion.

The proposed sensor-based monitoring and auditing process of buildings is helpful to obtain reliable and robust usage and activity detection. Thus, it is can be an important part of solutions that use such input for adaptive control—e.g. for lighting applications.

In summary, an apparatus and method for analyzing building auditing information to identify irregular usage patterns and incorrect audit information have been described. The auditing information, such as energy consumption, is analyzed using presence information at room or zone level. Based on pre-selected expectations, clustering is applied to data sets. By using different criteria, the clustering results are examined within every cluster and among clusters to find irregular information. Furthermore, through cross-checking with other background information, irregular usage pattern can be found and incorrect audit information can be identified, so that succeeding energy prediction and decision-support algorithms can work on a reliable set of profiles.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single processor, sensing unit or other unit may fulfil the functions of several items recited in the claims. The mere fact that certain measures are recited in mutually different dependent claims does not indicate that a combination of these measures cannot be used to advantage.

It is noted that the proposed solution according to the above embodiments can be implemented at least partially in software modules at the relevant functional blocks of FIG. 1. The resulting computer program product may comprise code means for causing a computer to carry out the steps of the above procedures or functions of FIG. 1. Hence, the procedural steps are produced by the computer program product when run on the computer.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope thereof.

The present invention relates to an apparatus and method for analyzing building auditing information to identify irregular usage patterns and incorrect audit information. The auditing information, such as energy consumption, is analyzed using presence information at room or zone level. Based on pre-selected expectations, clustering is applied to data sets. By using different criteria, the clustering results are examined within every cluster and among clusters to find irregular information. Furthermore, through cross-checking with other background information, irregular usage pattern can be found and incorrect audit information can be identified, so that succeeding energy prediction and decision-support algorithms can work on a reliable set of profiles.

1. An apparatus for analyzing a building energy/lighting auditing information retrieved by a monitoring system, said apparatus comprising: a dedicated or disturbed processor including:
a. a clustering unit for clustering data sets of said building energy/lighting auditing information based on at least one predetermined clustering criteria relating to a building's characteristics and/or energy/lighting usage pattern(s) to obtain clusters with a commonality;
b. a comparison unit for comparing clusters obtained by said clustering stage based on at least one predetermined comparison criteria to determine potential candidates for irregular or incorrect clusters; and
c. a checking unit for cross-checking candidates determined by said comparison stage with background information relating to a specific condition of the building's energy/lighting use including at least one of building room types(s), calendar information, time or user schedules to determine irregular energy/lighting usage patterns or incorrect auditing information.

2. The apparatus according to claim 1, further comprising an audit stage for processing auditing information from which incorrect data sets have been removed and for translating said auditing information into representative profiles.

3. The apparatus according to claim 1, wherein said checking stage is adapted to determine at least one root cause of irregularity and to correct a determined irregular data set into a regular data set based on said at least one root cause.

4. The apparatus according to claim 3, wherein said checking stage is adapted to correct said determined irregular data set based on at least one of an interpolation of valid measurement samples, a regression model, a rule model and a decision tree model.

5. The apparatus according to claim 1, wherein said auditing information comprises presence information and measurement values of energy consumption at a predetermined acquisition rate.

6. The apparatus according to claim 5, wherein said apparatus is adapted to apply an iterative approach, where said clustering stage first clusters data sets of a single area of a building or floor to determine irregular or incorrect patterns for said single areas and then clusters the areas in their entirety.

7. The apparatus according to claim 5, wherein said clustering stage is adapted to use a distance between presence profiles as said predetermined clustering criteria.

8. The apparatus according to claim 7, wherein said clustering stage is adapted to apply a clustering algorithm to cluster the profile using said distance.

9. A method of analyzing auditing information retrieved by a monitoring system, said method comprising:
a. clustering data sets of said auditing information based on at least one predetermined clustering criteria to obtain clusters with a sufficient commonality;
b. comparing obtained clusters based on at least one predetermined comparison criteria to determine potential candidates for irregular or incorrect clusters; and
c. cross-checking determined candidates with background information to determine irregular usage patterns or incorrect auditing information.

10. The method according to claim 9, further comprising processing auditing information from which incorrect data sets have been removed and translating said auditing information into representative profiles.

11. The method according to claim 10, further comprising determining at least one root cause of irregularity and correcting a determined irregular data set into a regular data set based on said at least one root cause.

12. The method according to claim 11, further comprising correcting said determined irregular data set based on at least one of an interpolation of valid measurement samples, a regression model, a rule model and a decision tree model.

13. The method according to claim 9, wherein said auditing information comprises presence information and measurement values of energy consumption at a predetermined acquisition rate.

14. The method according to claim 13, further comprising using a distance between presence profiles as said predetermined clustering criteria.

15. The method according to claim 14, further comprising applying a clustering algorithm to cluster the profile using said distance.

16. A computer program product comprising code means for producting the steps of claim 9 when run on a computing device.
